(19) United States
(12) Patent Application Publication
(10) Pub. No.: US 2008/0034180 A1
(43) Pub. Date: Feb. 7, 2008

(54) Apparatus and method for processing storage medium and program therefor

(75) Inventors: Hiroki Shiina, Kanagawa (JP); Kenichiro Aridome, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/880,881

(22) Filed: Jul. 24, 2007

(30) Foreign Application Priority Data
Aug. 2, 2006 (JP) P2006-211030

(51) Int. Cl. G06F 12/02

(52) U.S. Cl. 711/170; 711/E12.002

(57) ABSTRACT

A storage medium processing apparatus may include a recognizing unit which sequentially executes logical-format-specific recognizing operations included in a storage-medium recognizing process for recognizing a storage medium loaded in a loading mechanism of the apparatus so that the medium is operable in a software layer, the storage medium having a predetermined physical format that supports two or more logical formats, the logical-format-specific recognizing operations being related to the logical formats, respectively. A generating unit may generate logical-format historical information synchronously with the execution of a predetermined process, the information containing a history of logical formats specified by the predetermined processes performed on storage media loaded in the loading mechanism in the past. A storing unit may store the information. An execution-order control unit may determine the execution order of the mounting operations to be executed in accordance with the frequencies of occurrence of the respective logical formats described in the stored information.

### CROSS-REFERENCE TO RELATED APPLICATIONS

This application claims priority from Japanese Patent Application No. JP 2006-211030 filed in the Japanese Patent Office on Aug. 2, 2006, the entire content of which is incorporated herein by reference.

### BACKGROUND OF THE INVENTION

1. Field of the Invention

The present invention relates to an apparatus and method for processing a storage medium, and a program executed in the apparatus, the apparatus and method performing preprocessing before an operation, such as reading or writing data from/to one of various storage media, in each of which a predetermined physical format and a predetermined logical format are defined.

2. Description of the Related Art

In an apparatus having a drive capable of reading and/or writing data to/from a predetermined type of storage medium, a process of recognizing a loaded storage medium is executed under the control of, fore example, software in a predetermined layer within a hierarchy of layers. This process is called “mounting (mount process)”. Consequently, descriptions of stored data including the directory structure of the storage medium are recognized in the software layer, so that an operation, such as writing or reading data, can be performed.

In some of storage media, one physical format having (supporting) a plurality of logical formats is defined. For example, the DVD-RW format is known as one of digital versatile disc (DVD) physical formats. Generally, the DVD-RW format supports at least two logical formats, i.e., DVD-Video and DVD-Video Recording Format (hereinafter, DVD-VR). Therefore, a formatted DVD-RW disc may have been formatted in either the DVD-Video format or the DVD-VR format.

In accordance with the above-described specification in which one physical format supports two or more logical formats, some of known storage-medium drives and apparatuses each including such a drive are designed so that a plurality of logical formats are available in media having a certain physical format.

In the drives and the apparatuses including the drive which can process a storage medium whose physical format supports a plurality of logical formats, it is necessary to arrange a function of performing mounting based on an algorithm specific to each logical format.

During mounting, a predetermined management area is accessed in accordance with a file system format defined by a logical format of a storage medium and the logical structure thereof. If the storage medium is recognized, the mounting is completed normally. Generally, the file system format and the logical structure of a storage medium determined by formatting depend on a logical format applied to the storage medium. Therefore, if mounting based on an algorithm specific to a certain logical format is performed on a storage medium formatted in another logical format, the mounting results in an error. Since an algorithm for mounting is specific to each logical format as described above, therefore, the algorithm should be appropriately changed to another one.

As disclosed in Japanese Unexamined Patent Application Publication No. 2002-50040, an apparatus compatible with storage media each having a predetermined physical format supporting a plurality of logical formats has a mounting function of performing a mount process including mounting operations based on algorithms for respective logical formats. When the mount process is actually performed, mounting operations based on respective algorithms are sequentially tried to be performed in a predetermined order, e.g., a default order of the logical formats. Specifically, a target storage medium is subjected to a mounting operation based on an algorithm suitable for a first logical format. If the operation results in an error, the storage medium is subsequently subjected to a mounting operation based on another algorithm suitable for a logical format following the first logical format. The mount process is performed in this manner. When a logical format related to a mounting operation finally matches the logical format actually used for formatting of the target storage medium, the mount process is completed normally.

### SUMMARY OF THE INVENTION

However, a mounting operation for each logical format takes relatively long time. Particularly, regarding disk-shaped storage media, such as DVDs, a predetermined storage area has to be accessed such that a signal surface of the storage medium is physically irradiated with laser light. Therefore, time required for the mount process tends to increase.

In a case where an apparatus compatible with storage media each having a predetermined physical format supporting a plurality of logical formats is designed so as to sequentially perform mounting operations in accordance with a predetermined order of the operations related to the respective logical formats as described above, if a logical format of a target storage medium matches that related to a mounting operation arranged in a later position in the predetermined order, it takes long time until the mount process is completed. In a general apparatus having a storage-medium drive, after a storage medium is loaded into the drive and a mount process is started, another process is not performed until the mount process is completed normally. Therefore, long time required for the mount process results in long waiting time of a user who handles the apparatus. Accordingly, it is desired that time required for the mount process should be reduced as much as possible.

According to an embodiment of the present invention, there is provided an apparatus for processing a storage medium, which may include the following: A recognizing unit sequentially executes logical-format-specific recognizing operations included in a storage-medium recognizing process for recognizing a storage medium loaded in a loading mechanism of the apparatus so that the storage medium is operable in a software layer, the storage medium having a predetermined physical format that supports two or more logical formats, the logical-format-specific recognizing operations being related to the logical formats, respectively. A generating unit may generate logical-format historical information synchronously with the execution of a predetermined process, the logical-format historical information may contain a history of logical formats specified by the predetermined processes performed on storage media loaded in the loading mechanism in the past. A storing unit may store the logical-format historical information. An execution-order control unit may determine the execution order of the logical-format-specific mounting operations executed by the recognizing unit in accordance with the frequencies of occurrence of the respective logical formats described in the logical-format historical information stored in the storing unit.

In the apparatus with the above-described structure, the storage-medium recognizing process may be performed to recognize a storage medium loaded in the loading mechanism of the apparatus so that the storage medium may be operable in a software layer, the storage medium having a predetermined physical format that supports two or more logical formats. This process may generally be called “mounting. The storage-medium recognizing process may include the logical-format-specific recognizing operations and may be performed such that the logical-format-specific recognizing operations for the respective logical formats defined in the predetermined physical format are sequentially executed.

In this embodiment, logical-format historical information may be generated. The logical-format historical information may contain a history of logical formats specified by the predetermined processes performed on storage media loaded in the loading mechanism in the past. The execution order of the logical-format-specific recognizing operations may be determined in accordance with the frequencies of occurrence of the respective logical formats described in the logical-format historical information.

Consequently, the execution order of the logical-format-specific recognizing operations in the storage-medium recognizing process can be set in decreasing order of the frequency of occurrence of a logical format described in the logical-format historical information. Since the logical-format historical information may regard a history of logical formats specified by the predetermined processes performed on loaded storage media, the high frequency of occurrence of a logical format described in the logical-format historical information may represent which logical format a user often uses in storage media loaded in the apparatus, i.e., the user preference for the logical format. Therefore, the execution order of the logical-format-specific recognizing operations determined in accordance with the embodiment may match the user preference.

Since the execution order of the logical-format-specific recognizing operations may match the user preference as described above, it is highly possible that the storage-medium recognizing process may be normally completed by the logical-format-specific recognizing operation arranged in the first position or a position close to the first position in the execution order. In other words, it is highly possible that the storage-medium recognizing process may be finished at an early stage, thus reducing time required for mounting. This leads to reduced waiting time for the user during mounting, thus improving the ease of use of the apparatus.

### BRIEF DESCRIPTION OF THE DRAWINGS

FIG. 1 is a block diagram of a video camera according to an embodiment of the present invention;

FIG. 2 illustrates a list of DVD physical formats and logical formats which are available in the video camera according to the embodiment.

FIG. 3 is a diagram showing generated and stored mount historical information blocks related to respective DVD types in the embodiment;

FIGS. 4A and 4B illustrate descriptions of mount historical information blocks in a case where a physical format of a loaded DVD is the DVD-RW format;

FIG. 5 is a flowchart of a mount process involving determining the execution order of logical-format-specific mounting operations on the basis of mount historical information;

FIG. 6 is a flowchart of a process for generating execution-order information on the basis of mount historical information;

FIG. 7 illustrates descriptions of execution-order information;

FIG. 8 illustrates a DVD formatting screen;

FIG. 9 is a flowchart of formatting which involves determining arrangement of a highlight frame in the initial DVD formatting screen on the basis of mount historical information;

FIG. 10 is a diagram illustrating generated and stored mount historical information blocks and formatting historical information blocks related to respective DVD types according to a modification of the embodiment;

FIG. 11 is a flowchart of formatting which involves determining arrangement of the highlight frame in an initial DVD formatting screen on the basis of either mount historical information or formatting historical information; and

FIG. 12 is a flowchart of a mount process involving determining the execution order of logical-format-specific mounting operations on the basis of either mount historical information or formatting historical information.

### DETAILED DESCRIPTION

An embodiment of the present invention will be described below. In the following description, a video camera will be exemplified as an apparatus for processing a storage medium.

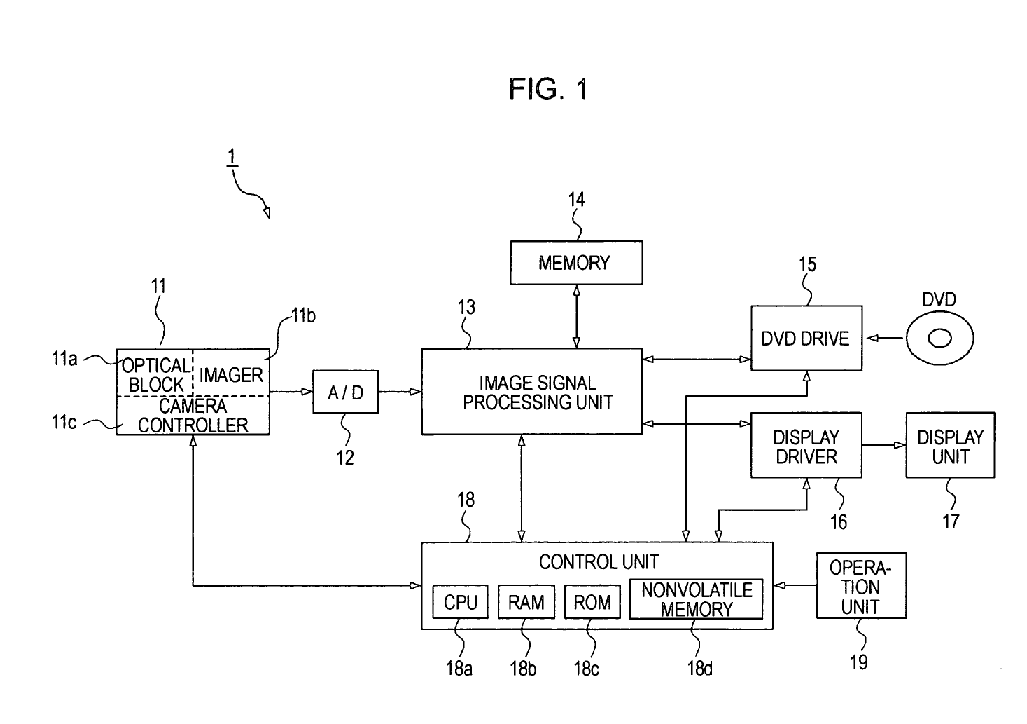

FIG. 1 is a block diagram of a video camera (apparatus) 1 according to an embodiment of the present invention.

Referring to FIG. 1, the video camera 1 includes a camera unit 11, which includes an optical block 11a, an imager 11b, and a camera controller 11c.

The optical block 11a includes a lens optical system, a focus mechanism, a shutter mechanism, and a diaphragm (iris) mechanism. The optical block 11a forms an image of incident light, serving as imaging light, on a light receiving surface of the imager 11b. In this case, it is assumed that focus control, shutter control, and variable control of an f number in the optical block 11a are performed in response to drive signals output from the camera controller 11c. In other words, the camera controller 11c generates drive signals for controlling the focus mechanism, the shutter mechanism, and the diaphragm mechanism in accordance with the control of a control unit 18 and then outputs the generated signals. The focus mechanism, the shutter mechanism, and the diaphragm mechanism operate in response to the drive signals, so that the focusing operation, the shutter operation, shutter speed, and the f number are appropriately controlled.

The imager 11b includes a photoelectric transducer, such as a charge coupled device (CCD) or a CMOS sensor. The imager 11b converts imaging light received on the light receiving surface into electrical signals. The imager 11b sequentially outputs signal charge accumulated according to imaging light received on the light receiving surface at predetermined time intervals to output electrical signals corresponding to the imaging light. The camera controller 11c generates a drive signal indicating necessary time intervals in accordance with the control of the control unit 18 and outputs the drive signal to the imager 11b. The imager 11b outputs the signal charge at time intervals based on the drive signal.

Further, the imager 11b performs, for example, correlated double sampling (CDS) and automatic gain control (AGC) on an electrical signal output from part of the photoelectric transducer and outputs the resultant signal to an analog-to-digital (A/D) converter 12.

The A/D converter 12 converts the received electrical signal that is analog into a digital signal.

The digital signal, which is output from the A/D converter 12, based on the imaging light is supplied to an image signal processing unit 13. The image signal processing unit 13 serves as a digital signal processor (DSP) for image signal processing and executes predetermined digital signal processing, e.g., obtaining a digital image signal corresponding to a captured image from the input digital signal. In this case, the digital signal processing primarily includes two processes, i.e., a camera signal process as signal processing for camera control and a recording/reproducing signal process as signal processing for recording and reproducing a signal to/from a DVD, serving as a storage medium, handled by the video camera 1 according to the present embodiment as will be described later.

Regarding the camera signal process, predetermined signal processing based on various parameters for imaging control on the camera unit 11 is performed. In this case, imaging parameters of camera signal processing functions include autofocus (AF) control, exposure control, white balance processing, and image blur correction.

As for the recording/reproducing signal process, digital signal processing suitable for a format for recording/reproducing at least moving image data to/from a DVD is performed. In the present circumstances, a plurality of physical formats and a plurality of logical formats are defined in a DVD category. Examples of physical and logical formats available in the video camera 1 will be described later.

In various DVD formats, image data (moving image data) and audio data, which serve as main data, are generally subjected to compression encoding by a predetermined method. Regarding the recording/reproducing signal process by the image signal processing unit 13, therefore, the image signal processing unit 13 compresses and encodes the digital signals supplied from the A/D converter 12 and transfers the resultant signals, serving as a data stream in a predetermined format, to a DVD drive 15.

The DVD drive 15 includes a loading mechanism for receiving a removable DVD. A data write/read operation is performed on the DVD loaded in the loading mechanism in accordance with, for example, the control of the control unit 18. For example, when the DVD drive 15 receives the above-described data stream output from the image signal processing unit 13 and performs the data write operation on the loaded DVD, image data obtained by imaging is recorded onto the DVD.

To reproduce image data recorded on the DVD, the control unit 18 controls the DVD drive 15 to read the data from the DVD and supply the read data to the image signal processing unit 13.

The image signal processing unit 13 having a recording/reproducing signal processing function performs a decoding process, related to the above-described compression encoding, on the input data to obtain a digital image signal for display. The digital image signal can be output to a display driver 16. The display driver 16 drives a display unit 17 in accordance with the input digital image signal. Thus, the display unit 17 displays the captured image based on the digital image signal reproduced from the DVD. The digital image signal for display in a predetermined format may be output to an external display (not shown) so that the image is displayed on the external display.

The image signal processing unit 13 can perform signal processing for allowing the display unit 17 to display a monitor image during image capture. In this case, for example, a digital image signal based on a digital signal supplied from the A/D converter 12 is output to the display driver 16.

As for a display actually used as the display unit 17, various displays, such as a liquid crystal display, may be available.

The image signal processing unit 13 uses a memory 14 including, for example, an SDRAM, as a work area during performing various signal processes as described above. The image signal processing unit 13 has therein a memory controller for the memory 14. The memory controller performs data read/write control on the memory 14.

The control unit 18 controls respective components of the video camera 1 and includes a microcomputer including a central processing unit (CPU) 18a, a random access memory (RAM) 18b, a read only memory (ROM) 18c, and a nonvolatile memory 18d.

The RAM 18b is mainly used as a work area of the CPU 18a. For example, the RAM 18b temporarily stores an arithmetic result obtained by the CPU 18a. The ROM 18c stores a program to be executed by the CPU 18a and setting data necessary for various processes. The program may be stored in the ROM 18c such that the program is written into the ROM 18c during, for example, manufacturing the video camera 1. Alternatively, the program may be stored in, for example, a removable recording medium and data of the program may be installed from the medium onto the ROM 18c.

The nonvolatile memory 18d includes a memory device, such as a flash memory, capable of retaining stored data after the power is turned off. The CPU 18a controls data read/write operations on the nonvolatile memory 18d. As for data (information) to be stored in the nonvolatile memory 18d, information regarding logical formats is mainly stored in the nonvolatile memory 18d in this embodiment. The nonvolatile memory 18d may store other information in addition to the above-described information.

An operation unit 19 includes manual controllers, e.g., a touch panel and various switches and buttons arranged in predetermined positions in a housing of the video camera 1. The operation unit 19 outputs an operation information signal according to an operation to the control unit 18. The CPU 18a in the control unit 18 performs a predetermined control or process in response to the supplied operation information signal.

General imaging apparatuses are capable of recording sound captured by a microphone during, for example, image capture as audio data in addition to image data of a simultaneously captured image. Such audio data is recorded or reproduced synchronously with the corresponding image data. In the video camera 1 according to the present embodiment, image data of a captured image and audio data of the corresponding captured sound are multiplexed and recorded as a data stream so that the image data is reproduced synchronously with the audio data. For ease of explanation, a recording/reproducing system for audio data is omitted in FIG. 1.

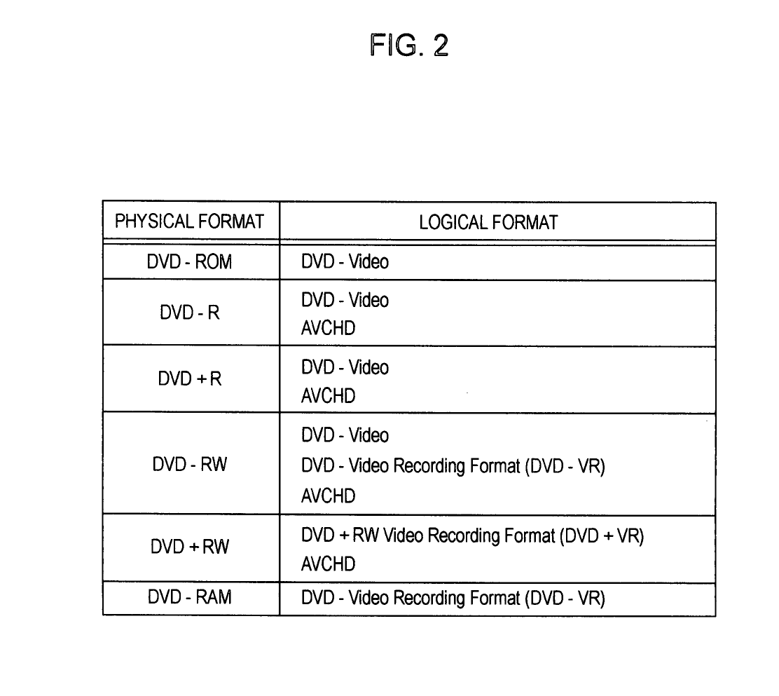

As described above, the video camera 1 according to the present embodiment is capable of storing information related to a captured image onto a DVD. Under present circumstances, physical formats and logical formats exist in the DVD category. For example, regarding a disk-shaped storage medium, the term “physical format” means a defined structure for physical specifications, such as the physical compositions of signals and a track format. On the other hand, the term “logical format” means a defined structure for logical specifications of a logical storage layout defined on a predetermined physical format. In the present embodiment, the video camera 1 is compatible with a plurality of DVD physical formats and each physical format can support a plurality of logical formats. Examples of DVD formats which the video camera 1 according to the present embodiment is compatible with will now be described with reference to FIG. 2.

Referring to FIG. 2, the video camera 1 according to the present embodiment is compatible with six physical formats, i.e., the DVD-ROM, DVD-R, DVD+R, DVD-RW, DVD+RW, and DVD-RAM formats. The DVD-R format is a read-only type and each of the DVD-R and DVD+R formats is a recordable type in which data can be recorded on a medium but data cannot be rewritten in a data recorded area of the medium. Each of the DVD-RW, DVD+RW, and DVD-RAM formats is a rewritable type.

Logical formats supported by the respective physical formats will now be described.

The DVD-ROM format supports only the DVD-Video format. The DVD-R and DVD+R formats each support two logical formats, i.e., the DVD-Video format and the AVCHD format. The DVD-RW format supports three logical formats, i.e., the DVD-Video format, the DVD-VR format, and the AVCHD format. The DVD+RW format supports two logical formats, i.e., the DVD+RW Video Recording Format (hereinafter, referred to as “DVD+VR”) and the AVCHD format. The DVD-RAM format supports only the DVD-VR format.

In the video camera 1 according to the present embodiment, the DVD drive 15, the recording/reproducing signal processing system in the image signal processing unit 13, and the program to be executed by the CPU 18a should be designed so as to support any of the combinations of the physical formats and the logical formats shown in FIG. 2.

For example, the DVD drive 15 should be designed so as to perform laser power control, servo control, and processing in a driver layer suitable for each physical format.

For example, the DVD-Video, DVD-VR, and DVD+VR formats use a compression encoding method based on MPEG2. The AVCHD format is used for high definition recording of higher quality images and uses a compression encoding method based on MPEG4-AVC/H.264. Accordingly, in the image signal processing unit 13, for example, at least a codec for dealing with compression encoding should be designed to as to perform signal processing suitable for each logical format.

The program should be designed such that program parts having various predetermined functions support various logical formats. A program for a mount process is provided as one of the program parts that should support the logical formats.

The term “mount process” here means a process called medium recognition. In the present embodiment, the mount process is performed in order to allow a software layer installed in the video camera 1 to recognize a DVD loaded in the DVD drive 15 using, for example, the directory structure of the DVD.

For example, in a personal computer, the mount process is performed in operating system (OS) layers automatically or in response to an input command. In the video camera 1 according to the present embodiment, the CPU 18a executes a program corresponding to, for example, an OS function to realize the mount process.

The mount process is generally realized as follows: An instruction to access to a predetermined management information area in a target storage medium to be subjected to the mount process is issued in accordance with a file system format specified according to the logical format of the storage medium and the logical structure of storage areas of the medium, so that management information is read from the management information area. The read information is interpreted, thus realizing the mount process.

Generally, if a logical format is different, a file system version or format and the logical structure of storage areas formed in a storage medium are also different. Accordingly, descriptions of a control procedure to be performed in the mount process are also different. In order to support a plurality of logical formats, therefore, it is necessary to arrange algorithms suitable for the respective logical formats in a program for the mount process.

In the present embodiment, the four logical formats, i.e., the DVD-Video, DVD-VR, DVD+VR, and AVCHD formats are available in the six physical formats. Major differences among those logical formats will now be described.

First, the DVD-Video format uses a bridge format for the ISO9660 and Universal Disc Format (UDF) 1.02 file systems. In each file system, the root directory has the VIDEO_TS directory.

The DVD-VR format uses the UDF 2.00 file system whose root directory has the DVD_RTAV directory.

The DVD+VR format uses a bridge format for the ISO9660 and UDF 1.02 file systems in a manner similar to the DVD-Video format. Unlike the DVD-Video format, the root directory has the VIDEO_RM directory in addition to the VIDEO_TS directory.

The AVCHD format uses the UDF 2.50 file system whose root directory has the BDMV directory.

A program for the mount process in the present embodiment includes program elements corresponding to the algorithms designed for the respective logical formats in consideration of the above-described differences among the logical formats.

As described above, the video camera 1 according to the present embodiment can perform the mount process including mounting operations (i.e., logical-format-specific mounting operations or logical-format-specific recognizing operations) based on algorithms suitable for respective logical formats to be supported. Providing that a physical format of a DVD loaded in the video camera 1 supports a plurality of logical formats, it is necessary to determine the order of the logical-format-specific mounting operations to be executed.

If a DVD is newly loaded into the DVD drive 15 of the video camera 1 according to the present embodiment, a physical format of the loaded DVD is recognized by an operation for physical format recognition by the DVD drive 15. The mount process is executed after the physical format is recognized.

It is assumed that the recognized physical format is the DVD-ROM or DVD-RAM format. As shown in FIG. 2, those physical formats each support one logical format. Therefore, the mount process may be executed based on the algorithm suitable for the logical format supported by the physical format. Generally, the mount process is successful (i.e., the storage medium is recognized or mounted) by one logical-format-specific mounting operation and the mount process is completed normally.

On the other hand, it is assumed that the recognized physical format is any of the DVD-R, DVD+R, DVD-RW, and DVD+RW formats other than the above-described DVD-ROM and DVD-RAM formats. Those physical formats each support two or more logical formats. Depending on, for example, file system specifications, however, if a logical format is not yet recognized after the physical format is recognized, the logical-format-specific mounting operations related to candidate logical formats have to be sequentially performed. In this instance, it is necessary to determine the execution order of the logical-format-specific mounting operations.

According to one of proper methods for determining the execution order of the logical-format-specific mounting operations, the execution order may be appropriately determined in advance. Actually, information designating the execution order of logical-format-specific mounting operations for each physical format is stored in, for example, a ROM. Upon executing the mount process, the information is read and the logical-format-specific mounting operations are sequentially performed in accordance with the designated execution order.

For example, it is assumed that a recognized physical format is the DVD-RW format. In this case, the three logical formats, i.e., the DVD-Video, DVD-VR, and AVCHD formats are regarded as candidates. Further, it is assumed that setting information designates the execution order of the logical-format-specific mounting operations such that the operations for the DVD-Video, DVD-VR, and AVCHD formats are executed in that order. If a logical format of a loaded DVD-RW disc is the AVCHD format, the first and second logical-format-specific mounting operations are not suitable for the AVCHD format because they are suitable for the DVD-Video and DVD-VR formats, respectively. Thus, each of the first and second mounting operations results in an error. When the third logical-format-specific mounting operation suitable for the AVCHD format is executed, the mount process is successful at this stage.

As described above, in the case where the execution order of the logical-format-specific mounting operations is set and those operations are sequentially in accordance with that order during the mount process, so long as a storage medium is formatted in an appropriate logical format, the medium is finally mounted successfully.

However, the above-described mount process has the following problem.

For example, it is assumed that a user often uses the AVCHD format as a logical format in the above-described DVD-RW format by preference and the predetermined execution order of the logical-format-specific mounting operations related to the DVD-RW format is the same as that of the above-described example, i.e., the operations for the DVD-Video, DVD-VR, and AVCHD formats are executed in that order.

Accordingly, when the user loads a DVD-RW disc formatted in the AVCHD format into the video camera 1, the mount process is completed after the termination of the third (final) logical-format-specific mount operation. Since the user uses the AVCHD format as a logical format by preference, it is highly possible that a DVD which the user loads into the video camera 1 is completely mounted after the final logical-format-specific mounting operation is executed.

Actually, one logical-format-specific mounting operation needs considerable time. Particularly, in case of a disk-shaped storage medium, such as a DVD, since access to the medium involves physical movement of a position irradiated with laser light for reading relative to the signal surface of the medium, it takes longer time than another storage medium, e.g., a semiconductor memory device.

If the mount process is completed at the termination of the last logical-format-specific mounting operation or a logical-format-specific mounting operation arranged in a position close to the last position, the entire mount process takes much longer time.

An operation related to a captured image, e.g., recording or reproducing data of the image is not performed until the mount process is completed. Therefore, a period of time elapsed after a DVD is loaded until the mount process is completed serves as waiting time for the user. If a logical-format-specific mounting operation for a logical format that the user often uses by preference is arranged in a later position in the sequence (i.e., execution order) of the logical-format-specific mounting operations, it is highly possible that waiting time required after the DVD is loaded until an operation can be performed is considerably extended. Disadvantageously, such circumstances may give stress to the user and may also reduce the ease of use of the apparatus. It is preferable to reduce the waiting time.

Therefore, the present embodiment of the present invention proposes a structure for determining the execution order of logical-format-specific mounting operations to suit a user preference for a logical format, thus reducing waiting time required until a mount process is completed as much as possible. This point will now be described below.

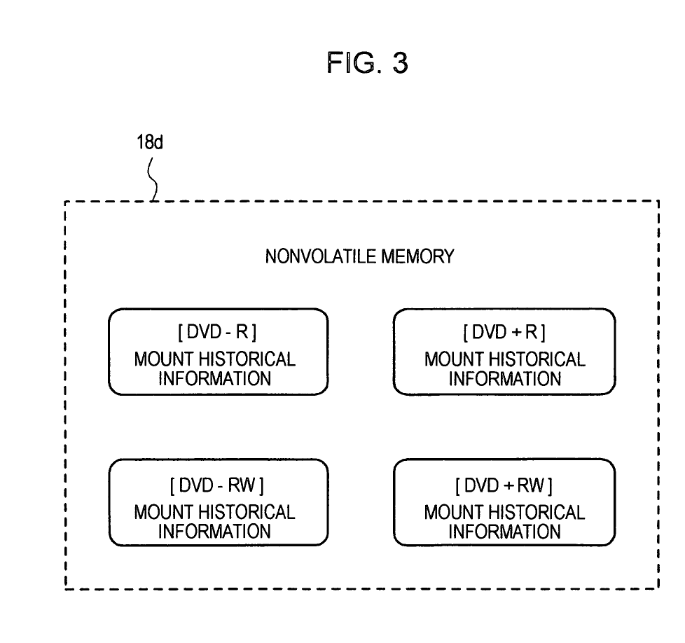

According to the present embodiment, for the purpose of adapting the execution order of logical-format-specific mounting operations to the user preference as described above, mount historical information related to each predetermined DVD physical format is generated as shown in FIG. 3 and is stored in, for example, the nonvolatile memory 18d of the control unit 18. Referring to FIG. 3, four mount historical information blocks related to the four DVD physical formats, i.e., the DVD-R, DVD+R, DVD-RW, and DVD+RW formats are shown.

Since it is unnecessary to generate and store mount historical information blocks related to the other physical formats, i.e., the DVD-ROM and the DVD-RAM formats, those information blocks are omitted. As will be described later, mount historical information is used to refer to the frequencies of occurrence of logical formats for a DVD physical format related to the information in order to determine the execution order of logical-format-specific mounting operations in a mount process performed on a DVD. It is therefore effective to generate mount historical information with respect to a physical format, such as DVD-R, DVD+R, DVD-RW, or DVD+RW, supporting two or more logical formats. It is useless to generate mount historical information with respect to a physical format, such as DVD-ROM or DVD-RAM, supporting only one logical format.

Mount historical information shown in FIG. 3 indicates a history of logical formats related to logical-format-specific mounting operations succeeded in mount processes performed each time a DVD in a physical format related to the mount historical information is loaded. In other words, when a logical-format-specific mounting operation arranged in a certain position in the execution order is successful during a mount process, the logical format of the loaded DVD is specified. Therefore, the mount historical information can describe a history of logical formats specified by mount processes performed on target DVDs in the related physical format.

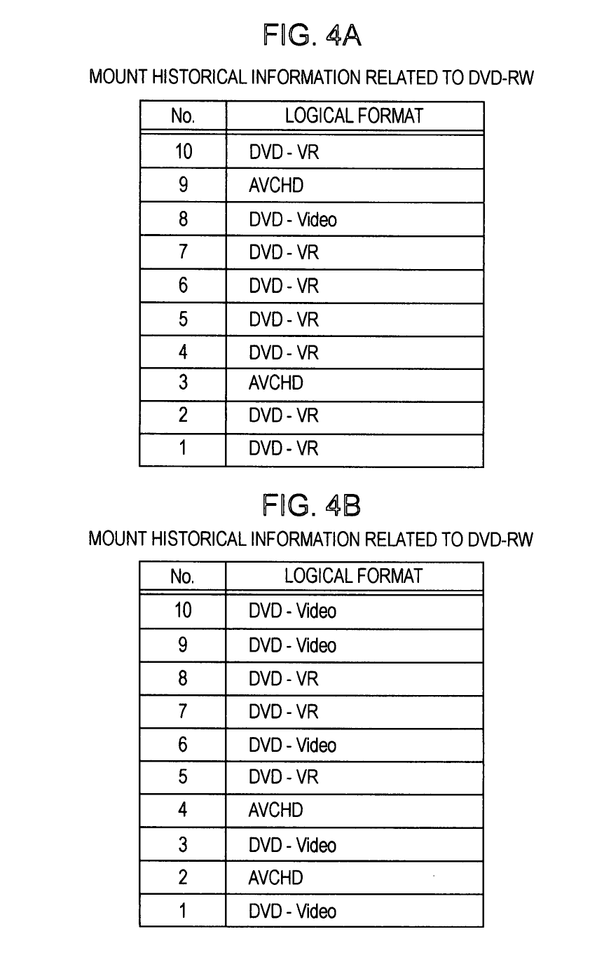

FIG. 4A illustrates descriptions of mount historical information. FIG. 4A shows mount historical information related to the DVD-RW format, one of the four mount historical information blocks shown in FIG. 3.

Referring to FIG. 4A, the mount historical information includes historical items Nos. 1 to 10. The historical item No. 1 corresponds to the latest mount process performed on a DVD-RW disc. The following historical items Nos. 2 to 10 correspond to first previous and subsequent mount processes performed on DVD-RW discs. Data indicating a logical format specified by a mount process is stored and registered in each of the historical items Nos. 1 to 10.

Since the DVD-RW format, serving as a physical format, supports three logical formats, such as DVD-Video, DVD-VR, and AVCHD, data indicating any of those logical formats is registered in each of the historical items Nos. 1 to 10. For example, when a mount process is performed on a newly loaded DVD-RW disc in the state shown in FIG. 4, data indicating a logical format specified by this mount process is registered in the historical item No. 1. Thus, data blocks registered in the historical items Nos. 1 to 9 are shifted such that those data blocks are registered in the historical items Nos. 2 to 10. Data registered in the historical item No. 10 before shifting is discarded. In other words, the mount historical information in FIG. 4A contains the results of most recent ten mount processes performed on DVDs in the physical format related to this mount historical information.

FIG. 4B illustrates mount historical information related to the same DVD-RW format as that in FIG. 4A. Providing that the mount historical information in FIG. 4A contains the results of previous mount processes, the mount historical information shown in FIG. 4B contains the results of mount processes performed after a lapse of relatively long time, e.g., several weeks or months after execution of the mount processes shown in FIG. 4A.

For example, as for the respective numbers of registered logical formats in the mount historical information of FIG. 4A, the number of registrations regarding the DVD-Video format is one, that regarding the DVD-VR format is seven, and that regarding the AVCHD format is two. On the other hand, in the mount historical information of FIG. 4B, the number of registrations regarding the DVD-Video format is five, that regarding the DVD-VR format is three, and that regarding the AVCHD format is two.

For comparison between the information blocks in FIGS. 4A and 4B, DVD-RW discs formatted in the DVD-VR format were most frequently loaded in the video camera 1 in the past as described in the information of FIG. 4A. After that, DVD-RW discs formatted in the DVD-Video format were most frequently loaded in the video camera 1 as described in the information of FIG. 4B. It is therefore estimated that the user preference has changed. In other words, although the user of the video camera 1 according to the present embodiment often used the DVD-VR format as a logical format upon using a DVD-RW disc as a storage medium in the past, the user tends to use the DVD-Video format.

Since mount historical information describes the results of most recent mount processes whose number is predetermined, the mount historical information appropriately reflects a change of the user preference for a logical format over time.

As for mount historical information blocks related to the remaining DVD-R, DVD+R, and DVD+RW formats, data blocks indicating logical formats specified by a predetermined number of most recent mount processes are registered in the same way as arrangements of FIGS. 4A and 4B.

In FIGS. 4A and 4B, the mount historical information includes ten historical items corresponding to most recent mount processes. The number of historical items in mount historical information may be appropriately changed in accordance with various conditions based on, for example, actual usage of the apparatus. Further, it is unnecessary that mount historical information blocks related to the DVD-R, DVD+R, DVD-RW, and DVD+RW formats (i.e., different physical formats) have the same number of historical items.

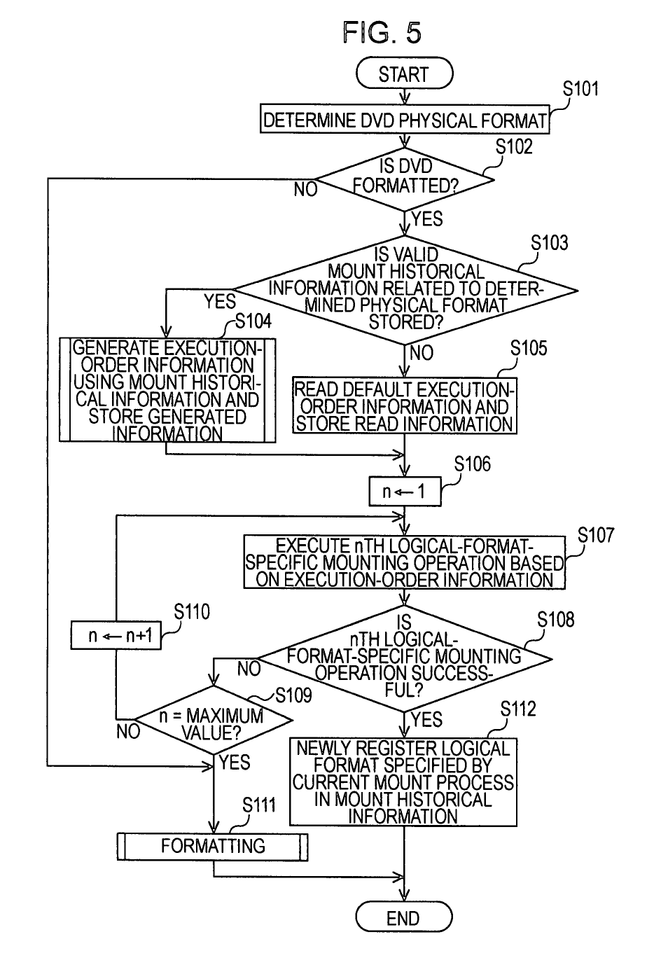

When the video camera 1 according to the present embodiment performs a mount process on a DVD in a physical format having a plurality of logical formats, the execution order of logical-format-specific mounting operations is determined on the basis of mount historical information related to the physical format as described above. The mount process will now be described with reference to a flowchart of FIG. 5. The CPU 18a of the control unit 18 shown in FIG. 1 executes a program stored in the ROM 18c or the nonvolatile memory 18d to control respective components and predetermined functional blocks shown in FIG. 1 execute operations in accordance with the control, thus realizing the process in FIG. 5.

The program may be written and stored in the ROM 18c during, for example, manufacturing. In the present embodiment, the program may be stored in a removable storage medium, such as a DVD, and be installed from the medium onto the nonvolatile memory 18d. Alternatively, the program may be stored in a storage device in a server over a network and be downloaded and installed onto the video camera 1 via the network.

For example, when the DVD drive 15 of the video camera 1 according to the present embodiment detects a DVD newly loaded in the loading mechanism, the mount process of FIG. 5 is started.

When the DVD is loaded into the loading mechanism of the DVD drive 15 as described above, the DVD drive 15 drives the loaded DVD in a predetermined manner. For example, the DVD drive 15 applies laser light to a predetermined area of the DVD to detect information regarding, for example, a physical format of the DVD. In step S101, the CPU 18a receives information regarding the physical format detected by the DVD drive 15 to recognize the physical format of the loaded DVD.

In step S102, it is determined whether the loaded DVD is formatted. The term “formatting” means a process for setting areas in a storage medium in accordance with a logical structure according to a predetermined logical format. Whether the loaded DVD is formatted can be determined on the basis of the information in the predetermined area in the DVD detected by the DVD drive 15 which executes an operation for physical format recognition.

If NO in step S102, i.e., it is determined that the loaded DVD is unformatted, the process proceeds to step S111 in which formatting is preformed. The formatting in step S111 will be described later.

If YES in step S102, i.e., it is determined that the loaded DVD is formatted, the process proceeds to step S103.

In step S103, it is determined whether the nonvolatile memory 18d stores “valid mount historical information” related to the physical format determined in step S101. In other words, not only the presence or absence of mount historical information in the nonvolatile memory 18d but also the validity of the stored mount historical information are determined. The validity of mount historical information can be determined using the following criteria.

As described above with reference to FIG. 3, mount historical information blocks related to physical formats each having a plurality of logical formats are stored. Therefore, when the physical format, like the DVD-ROM or DVD-RAM format, determined in step S101 has only one logical format, mount historical information related to the physical format is not stored. This is equivalent to the invalidity of mount historical information.

If the determined physical format has a plurality of logical formats and mount historical information related to the physical format is stored, the number of registered logical formats may not reach a prescribed number, for example, the number of registered logical formats may be one. In this case, the frequency of occurrence of the logical format indicated by the mount historical information may have low reliability. This mount historical information may be handled as invalid information. Providing that the number of registered logical formats is not prescribed, if the number of actually registered logical formats in mount historical information does not reach the number of historical items (ten items in each of FIGS. 4A and 4B), the mount historical information may be handled as valid information.

If YES in step S103, i.e., it is determined that valid mount historical information is stored in the nonvolatile memory 18d, the process proceeds to step S104.

In step S104, processing for generating information (hereinafter, execution-order information) indicating the execution order of logical-format-specific mounting operations is generated using the mount historical information and storing the generated information in, for example, the RAM 18b is executed.

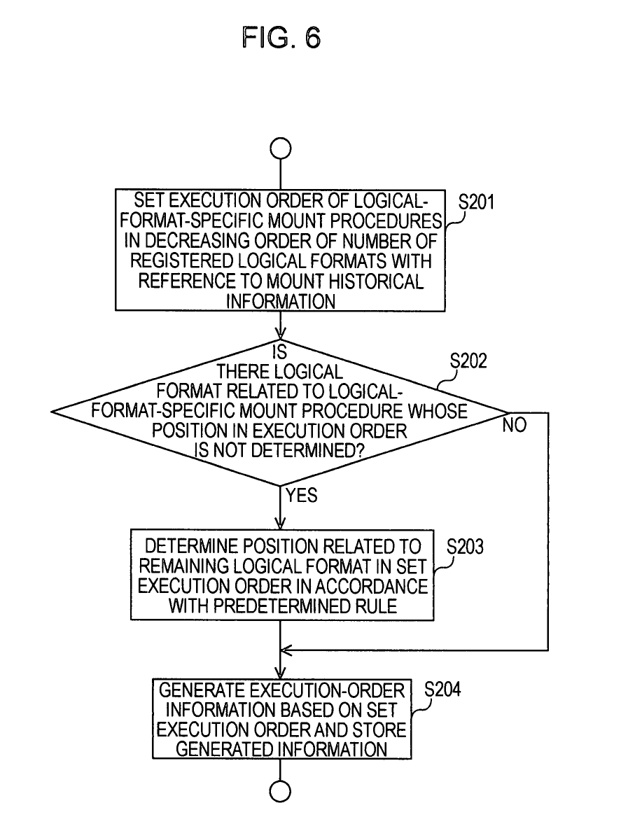

The processing for generating execution-order information and storing the information in step S104 in FIG. 5 will now be described with reference to a flowchart of FIG. 6.

Referring to FIG. 6, in step S201, mount historical information, for which it is determined in step S103 in FIG. 5 that the information is stored in the nonvolatile memory 18d, is referred to. The execution order of logical-format-specific mounting operations is determined in decreasing order of the number of registered logical formats. For example, assuming that mount historical information referred to in step S201 is that related to the DVD-RW format shown in FIG. 4B, the execution order is set such that a logical-format-specific mounting operation for the DVD-Video format is arranged in a first position in the execution order, that for the DVD-VR format is arranged in a second position, and that for the AVCHD format is arranged in a third position.

In step S202, it is determined whether there is a logical format whose related logical-format-specific mounting operation has no position in the execution order.

For example, regarding the information shown in FIG. 4B, the execution order of the logical-format-specific mounting operations related to all of the three logical formats for the DVD-RW format is set. In this case, a negative determination is made in step S202 and the process proceeds to step S204.

On the other hand, only one or two of the three logical formats for the DVD-RW format may be registered in mount historical information related to the DVD-RW format. In this case, the execution order of logical-format-specific mounting operations related to all of logical formats for the DVD-RW format is not set in step S201. Consequently, a logical format whose related logical-format-specific mounting operation has no position in the execution order remains. Therefore, a positive determination is made in step S202 and the process proceeds to step S203. After execution of step S203, the process proceeds to step S204.

In step S203, the position of the logical-format-specific mounting operation related to the remaining logical format is arranged in the execution order in accordance with a predetermined rule. The position is arranged so as to follow the last position in the execution order set in step S201. As for another rule for the execution order, the position may be arranged in accordance with the execution order indicated by default execution-order information, which will be described later.

In step S204, execution-order information indicating the execution order of logical-format-specific mounting operations is generated in accordance with the execution order set in the previous steps, since the execution order of the logical-format-specific mounting operations related to all of the logical formats for the determined physical format is set before step S204. The generated execution-order information is written (stored) into, for example, the RAM 18b.

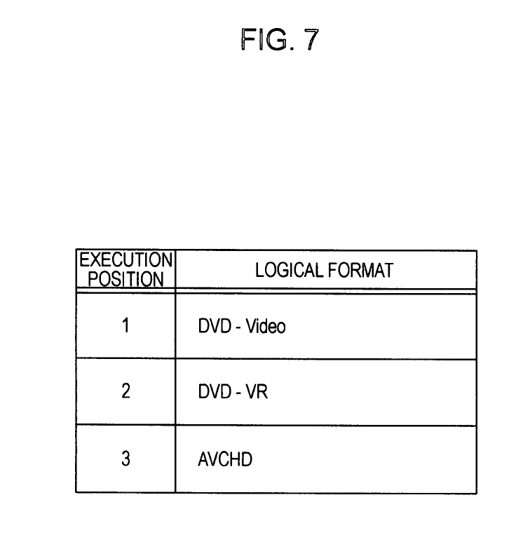

FIG. 7 shows descriptions of the execution-order information generated by the process of FIG. 6. The execution-order information reflects the mount historical information related to the DVD-RW format shown in FIG. 4B. Specifically, the execution-order information is generated in step S201 with reference to the mount historical information of FIG. 4B.

As described above, in the process of FIG. 6 based on the mount historical information of FIG. 4B, the execution order of the logical-format-specific mounting operations is set such that the logical-format-specific mounting operation for the DVD-Video format is arranged in the first position, that for the DVD-VR format is arranged in the second position, and that for the AVCHD format is arranged in the third position. Therefore, the execution-order information shown in FIG. 7 describes that the logical-format-specific mounting operations for the DVD-Video format, the DVD-VR format, and the AVCHD format are executed in that order.

Again referring to FIG. 5, if it is determined in step S103 that valid mount historical information is not stored (NO in step S103), the process proceeds to step S105. In other words, if a negative determination is made in step S103, execution-order information is not permitted to be generated on the basis of mount historical information as in step S104. According to the present embodiment, the video camera 1 allows, for example, the ROM 18c or the nonvolatile memory 18d to store default execution-order information indicating an appropriate execution order for each of the physical formats (DVD-R, DVD+R, DVD-RW, and DVD+RW) each having a plurality of physical formats. In step S105, therefore, default execution-order information for the physical format determined in step S101 is read and is stored into the RAM 18b.

After step S104 or S105, the RAM 18b stores the execution-order information. In step S106 and the subsequent steps, mounting is actually performed on the basis of the execution-order information stored in the RAM 18b.

In step S106, a value “1”, serving as an initial value, is assigned to a variable n representing the position of a logical-format-specific mounting operation to be performed in the execution order. The process then proceeds to step S107.

In step S107, the nth logical-format-specific mounting operation is performed on the basis of the execution-order information stored in the RAM 18b. In step S108, it is determined whether the logical-format-specific mounting operation in step S107 is successful.

If the logical format of the actually loaded DVD is different from the logical format related to the logical-format-specific mounting operation in step S107, the logical-format-specific mounting operation results in an error. Thus, a negative determination is made in step S108. In this instance, the variable n is incremented in step S110 until it is determined in step S109 that the currently set variable n is equal to a maximum value. The process is returned to step S107. In other words, when a logical-format-specific mounting operation arranged in a certain position in a certain execution order results in an error, another logical-format-specific mounting operation in the next position in the execution order indicated by execution-order information is performed. In this manner, the logical-format-specific mounting operations are sequentially performed in accordance with the execution order based on the execution-order information. When the logical format of the actually loaded DVD matches the logical format related to the logical-format-specific mounting operation performed at that time, the logical-format-specific mounting operation is successful. In other words, a positive determination is made in step S108. The mounting is completed in response to the positive determination made in step S108. Then, the process proceeds to step S112.

In step S112, the logical format specified by the current mount process is newly registered in the mount historical information. Specifically, among the mount historical information blocks stored in the nonvolatile memory 18d, the mount historical information related to the physical format determined in step S101 is accessed and is subjected to rewriting for new registration.

In the case where the negative determination is made in step S108 and other logical-format-specific mounting operations are sequentially performed, when each of the logical-format-specific mounting operations related to all of the logical formats for the determined physical format is not successful, a positive determination is made in step S109.

The reason why the positive determination is made in step S109 is considered as follows: The loaded DVD may be formatted in a special logical format which is not available in the video camera 1 according to the present embodiment. Alternatively, although the loaded DVD is formatted in an available logical format, data written in an area to be accessed during mounting may be corrupted for some reason. In other words, it is assumed that the loaded DVD is incorrectly formatted and mounting is not completed normally in the video camera 1 according to the present embodiment. In this instance, formatting in step S111 is performed as in the case where it is determined in step S102 that the DVD is unformatted. The formatting will be described in detail below. According to this process, the loaded DVD can be formatted in accordance with a user operation.

As described above, in the video camera 1 according to the present embodiment, mount historical information indicating a history of logical formats specified by predetermined number of most recent mount processes is generated and stored. The execution order of logical-format-specific mounting operations is determined on the basis of the mount historical information before a mount process and the mount process is then actually carried out.

The execution order of logical-format-specific mounting operations based on mount historical information reflects the user's current preference regarding a logical format. Actually, therefore, it is highly possible that a mount process on a DVD loaded by the user is completed by a logical-format-specific mounting operation in the first position or a position close to the first position in the execution order. This means that time required for the mount process tends to be reduced in total. As the time required for the mount process becomes shorter, waiting time for the user of the video camera 1 is reduced, thus improving the ease of use of the video camera 1.

As understood from the above description, mount historical information indicates a history of logical formats specified by predetermined number of most recent mount processes. As described above, the mount historical information indicates the user preference regarding a logical format for a DVD used by the user, i.e., which logical format the user preferably uses in a DVD.

Accordingly, mount historical information is useful for execution of a predetermined operation by the apparatus using the user preference or the frequencies of usage of logical formats in addition to determination of the execution order of logical-format-specific mounting operations in a mount process. According to the present embodiment, it is proposed that mount historical information is used when the user is allowed to perform an operation for DVD formatting as an operation other than the mount process. This case will be described below.

Before formatting a DVD loaded in the video camera 1 according to the present embodiment, in principle, the display unit 17 displays a DVD formatting screen, serving as a graphical user interface (GUI) screen used for the user to perform an operation for DVD formatting. The loaded DVD is formatted in a predetermined manner in accordance with a user operation on the DVD formatting screen.

The video camera 1 according to the present embodiment allows the display unit 17 to display the DVD formatting screen in either of the following two cases.

First, the DVD formatting screen is displayed upon formatting in step S111 in the process shown in FIG. 5. As described above, when it is determined that the loaded DVD is unformatted, or that the DVD is incorrectly formatted, the DVD formatting screen is displayed. In other words, the DVD formatting screen is displayed before formatting. The formatting in step S111 will be described in detail later.

Second, when the user intends to format a DVD and performs an operation of activating the DVD formatting screen on the video camera 1, the screen is displayed. When such an operation is performed, the mode of the video camera 1 is shifted to a formatting mode in the same way as in step S111, so that the DVD formatting screen is displayed.

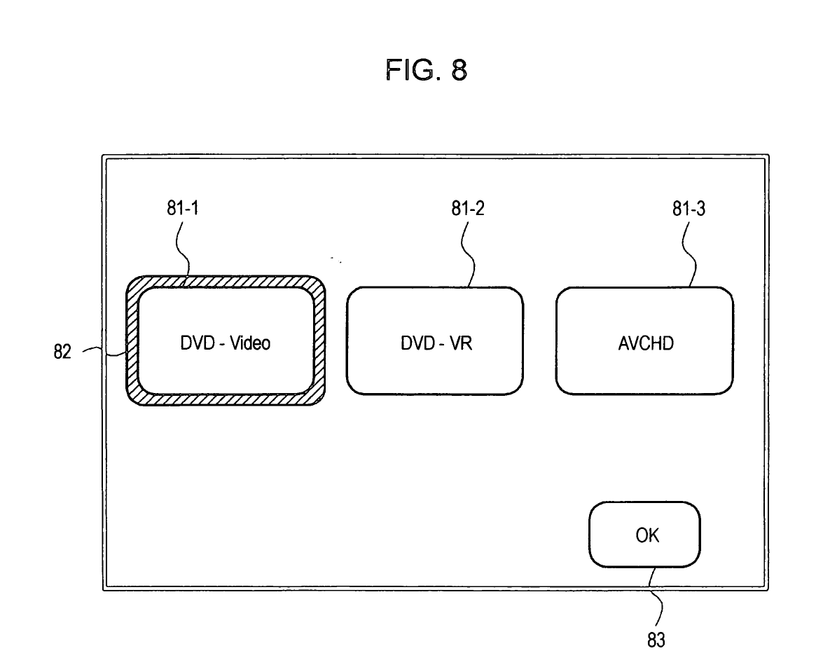

FIG. 8 illustrates the DVD formatting screen. In this example, it is assumed that the physical format of the loaded DVD is recognized as the DVD-RW format. In other words, the DVD formatting screen displays information suitable for each DVD physical format. Since the physical format of the loaded DVD is determined as the DVD-RW format, the DVD formatting screen suitable for the DVD-RW format is displayed.

Referring to FIG. 8, the DVD formatting screen includes three logical-format selection buttons (selection items) 81-1, 81-2, and 81-3. As described above with reference to FIG. 2, the DVD-RW format has the three logical formats, i.e., the DVD-Video, DVD-VR, and AVCHD formats. Accordingly, a DVD-RW disc can be formatted in any of the DVD-Video, DVD-VR, and AVCHD formats. In other words, the video camera 1 according to the present embodiment is constructed so that a rewritable DVD can be formatted in a logical format for the physical format of the DVD.

To format, for example, a DVD-RW disc in the video camera 1, therefore, any of the DVD-Video, DVD-VR, and AVCHD formats can be selected as a logical format used for formatting. The logical-format selection buttons 81-1, 81-2, and 81-3 are used when the user is allowed to select a logical format to be used for formatting.

The logical-format selection buttons 81-1, 81-2, and 81-3 are arranged laterally as illustrated in FIG. 8. The names of the respective formats, i.e., “DVD-Video”, “DVD-VR”, and “AVCHD” are assigned to those buttons 81-1, 81-2, and 81-3, respectively.

A highlight frame 82 representing a selected item is arranged in any of the logical-format selection buttons 81-1, 81-2, and 81-3. Referring to FIG. 8, the highlight frame 82 is arranged on the logical-format selection button 81-1. This means that the DVD-Video format corresponding to the logical-format selection button 81-1 is temporarily selected as a logical format for formatting.

The highlight frame 82 can be moved to any of the logical-format selection buttons 81-1, 81-2, and 81-3 in accordance with, for example, a predetermined operation performed by the user. In other words, the user can change a selected logical format to be used for formatting by moving the highlight frame 82. For example, when the display unit 17 has a touch panel as a screen, the user touches any of the logical-format selection buttons 81 displayed on the display unit 17, so that the highlight frame 82 can be moved to the touched button. Alternatively, an operation on a predetermined controller arranged on the video camera 1 enables movement of the highlight frame 82. Providing that the highlight frame 82 is arranged on a certain logical-format selection button 81 designating the logical format which the user intends to use it for formatting, the user operates an OK button 83 included in the same DVD formatting screen, so that the DVD is formatted in the logical format designated by the logical-format selection button 81 on which the highlight frame 82 is arranged at that time.

According to the present embodiment, before displaying the DVD formatting screen, when a plurality of logical formats are available for a DVD to be formatted, any of the logical-format selection buttons 81 on which the highlight frame 82 should be arranged is determined as follows.

In the video camera 1, when display of the DVD formatting screen is started, mount historical information related to the physical format of the loaded DVD to be formatted is referred to among mount historical information blocks stored in the nonvolatile memory 18d. The highlight frame 82 is arranged on the logical-format selection button 81 indicating the logical format having the largest number of registrations in the mount historical information.

As described above, the mount historical information reflects the user current preference for a logical format. In the case where the highlight frame 82 is displayed in the initial DVD formatting screen as described above, it is highly possible that the user uses the logical format designated by the logical-format selection button 81 highlighted with the highlight frame 82 upon formatting. If the user actually intends to format the DVD in the logical format designated by the highlight frame 82, the user may operate only the OK button 83.

For example, if mount historical information is not used, a logical format which the user intends to use for formatting cannot be estimated. In this instance, therefore, when display of the DVD formatting screen is started while the highlight frame 82 is simultaneously displayed, the highlight frame 82 is merely arranged on a predetermined logical-format selection button 81. Unfortunately, it is highly possible that a logical format which the user intends to use for formatting is different from the logical format designated by the highlight frame 82, therefore, the user performs an operation of moving the highlight frame 82. According to the present embodiment, it is unnecessary for the user to select a logical format for formatting, thus improving the ease of use of the apparatus.

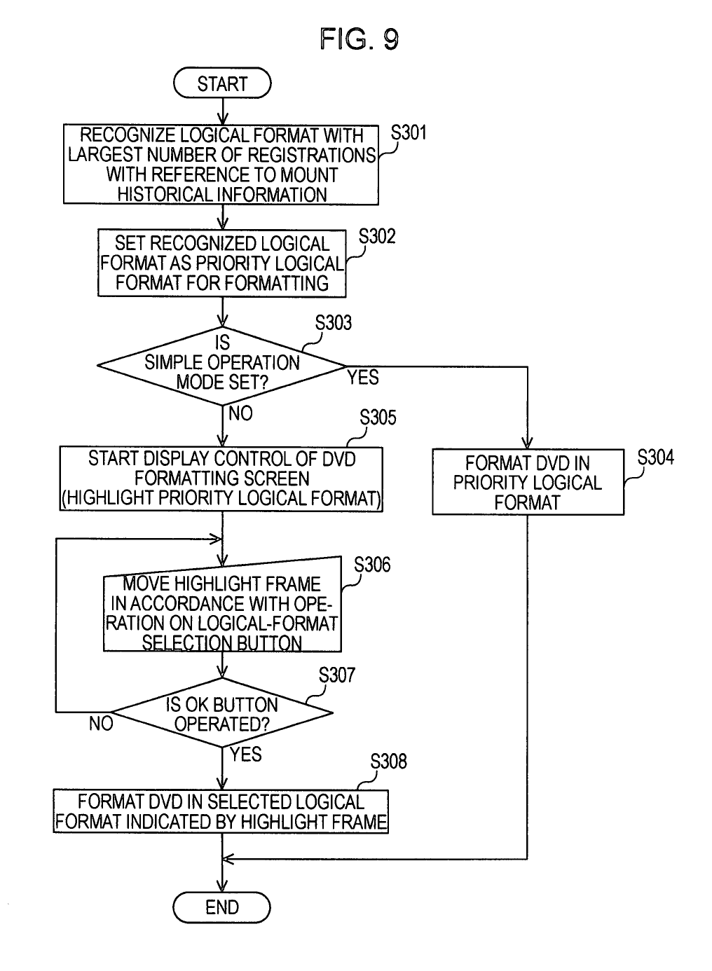

Formatting involving displaying the above-described DVD formatting screen will now be described with reference to a flowchart of FIG. 9. This process can be regarded as an operation realized by executing a program through the CPU 18a. The process of FIG. 9 corresponds to formatting in step S111 in FIG. 5.

Referring to FIG. 9, in step S301, among mount historical information blocks stored in the nonvolatile memory 18d, mount historical information related to a physical format of a loaded DVD is referred to and a logical format having the largest number of registrations is recognized. When there are two or more logical formats having the largest number of registrations, one logical format is selected in accordance with a predetermined rule and the selected logical format is handled as a recognized format. In step S302, the logical format recognized in step S301 is set as a priority logical format for formatting.

In step S303, it is determined whether a simple operation mode is set (i.e., enabled). In the simple operation mode, various parameters, which are changeable in a normal operation mode, cannot be changed but various operations based on default parameters set appropriately are automatically performed so that the user doesn't have to perform a complicated operation. When it is determined that the simple operation mode is set, the process proceeds to step S304. In step S304, the loaded DVD is formatted in the priority logical format set in step S302. Specifically, in the simple operation mode, the loaded DVD is immediately formatted in the logical format which is likely to be used by the user on the basis of the mount historical information without displaying the DVD formatting screen and allowing the user to select and determine a logical format on the screen.

On the other hand, if NO in step S303, the process proceeds to step S305.

In step S305, display control for starting display of the DVD formatting screen is performed. In this instance, the highlight frame 82 is arranged on a logical-format selection button 81 indicating the logical format, serving as the priority logical format set in step S302. Consequently, the highlight frame 82 is arranged on the logical-format selection button 81 indicating the logical format having the largest number of registrations in the mount historical information in the initial DVD formatting screen, as described above with reference to FIG. 8.

After the display of the DVD formatting screen is started as described above, in step S306, the highlight frame 82 is moved to a certain operated logical-format selection buttons 81 in accordance with the operation on the logical-format selection button 81, i.e., the operation of changing a logical format to be used for formatting.

In step S307, it is determined whether the OK button 83 is operated. If YES in step S307, the process proceeds to step S308. In step S308, the DVD is formatted in the logical format designated by the logical-format selection button 81 on which the highlight frame 82 is positioned when the OK button 83 is operated.

In the above-described process, the DVD formatting screen is displayed so that the user can select a logical format to be used for formatting and the loaded DVD is formatted. This means that a history of logical formats used for formatting reflects the user preference for a logical format.

According to a modification of the above-described embodiment, formatting historical information is generated and stored in place of mount historical information described above. On the basis of the formatting historical information, the above-described execution-order of logical-format-specific mounting operations in a mount process may be determined, or any of the logical-format selection buttons 81 to be highlighted with the highlight frame 82 may be determined in the initial DVD formatting screen.

The modification will be described below. First, formatting historical information will now be described.

Formatting historical information blocks related to DVD physical formats each having a plurality of logical formats are generated and are stored in the nonvolatile memory 18d in a manner similar to the mount historical information blocks illustrated in FIG. 3. Specifically, the formatting historical information blocks related to the DVD-R, DVD+R, DVD-RW, and DVD+RW formats are generated and stored.

The structure of formatting historical information related to each DVD physical format may conform to that of the mount historical information illustrated in FIG. 4A or 4B. Specifically, the formatting historical information contains registered data blocks indicating logical formats used (selected) in predetermined number of most recent formatting operations for the related physical format. Accordingly, the formatting historical information generated as described above can be treated as information indicating a history of logical formats specified as the results of predetermined processes, i.e., formatting operations as in the case of the mount historical information.

Processing that the video camera 1 should perform in order to determine the execution order of logical-format-specific mounting operations using formatting historical information may be performed in a manner similar to that in FIG. 5.

Specifically, in step S103, it is determined whether valid formatting historical information related to the physical format determined in step S101 is stored in the nonvolatile memory 18d in place of mount historical information. If YES in step S103, execution-order information may be generated using the valid formatting historical information in step S104.

Processing, involved in formatting, for determining any logical-format selection button 81 to be highlighted with the highlight frame 82 may be performed in a manner similar to that of FIG. 9. In this instance, in steps S301 and S302, a logical format having the largest number of registrations may be determined as a priority logical format for formatting with reference to formatting historical information related to the physical format of the loaded DVD in place of the mount historical information.

In the foregoing embodiment and the modification thereof, either mount historical information or formatting historical information is generated and stored. The execution order of logical-format-specific mounting operations in a mount process is determined on the basis of the stored historical information. Further, which logical-format selection button is highlighted with the highlight frame 82 in the initial DVD formatting screen is determined on the basis of the stored historical information. According to a second modification of the foregoing embodiment, both of mount historical information and formatting historical information may be generated and stored. Those historical information blocks may be properly used.

In this case, either the mount historical information or the formatting historical information can be selected as information with higher reliability and be used. As compared with the use of only one of the mount historical information and the formatting historical information, the user preference for a logical format can be more accurately reflected in the selected historical information. The second modification will now be described.

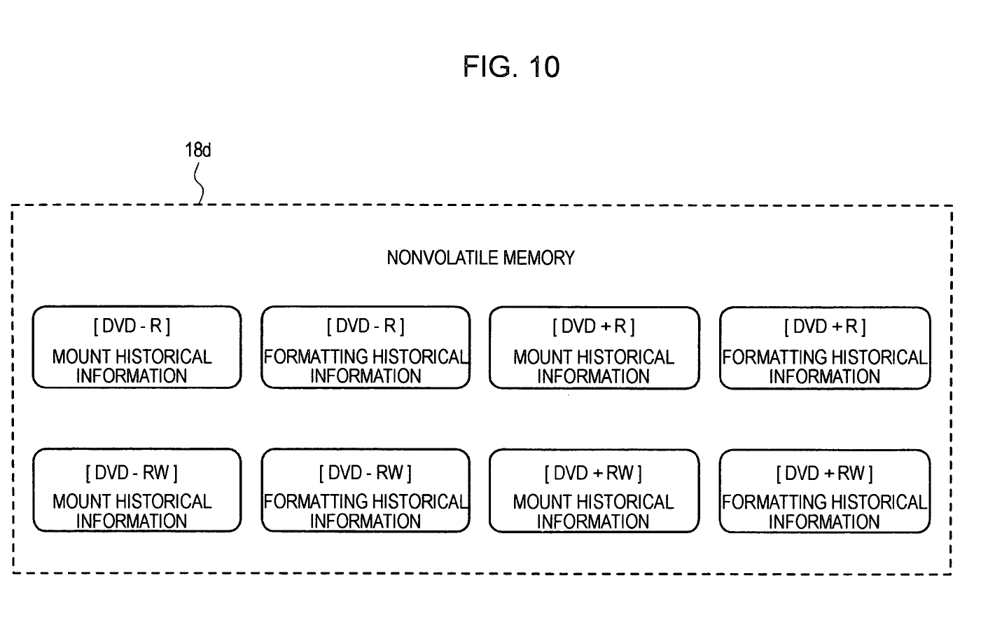

FIG. 10 illustrates information blocks in accordance with the second modification. Mount historical information blocks related to the DVD-R, DVD+R, DVD-RW, and DVD+RW formats and formatting historical information blocks related to those physical formats are generated and are stored in the nonvolatile memory 18d.

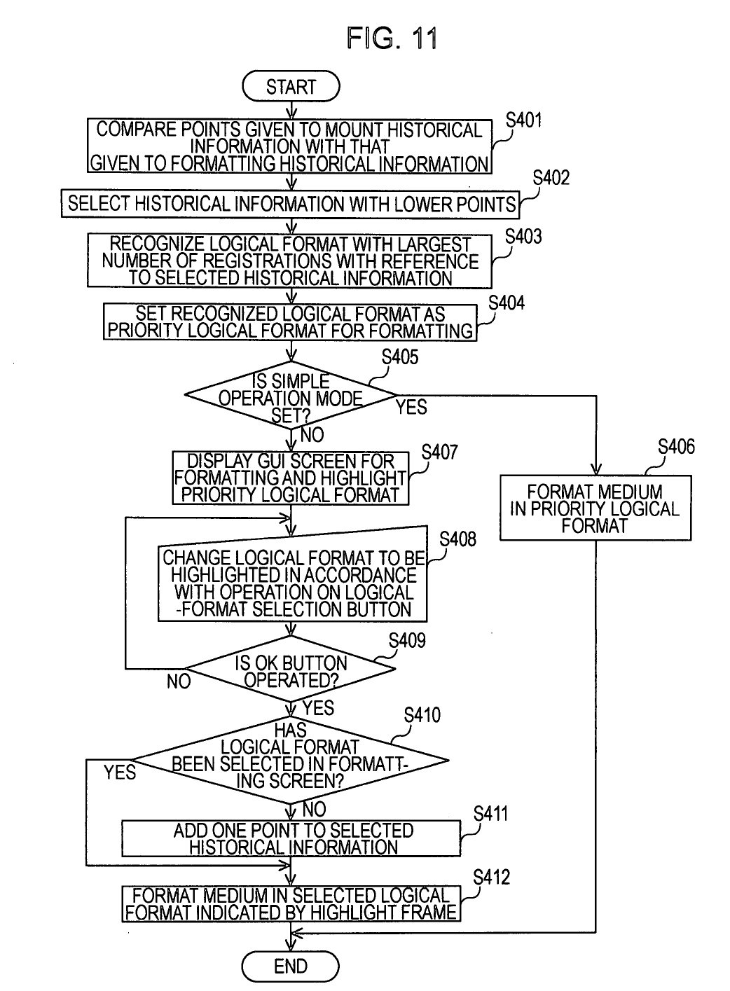

FIG. 11 shows a flowchart of formatting which involves initial display of a DVD formatting screen according to the second modification.

In step S401, points given to mount historical information related to a physical format of a loaded DVD to be formatted are compared with that given to formatting historical information related to the same physical format.

A point to be given to either of the mount historical information and the formatting historical information is added one by one in step S411, which will be described later. As will be understood from the following explanation, descriptions of historical information with higher points deviate from the user current preference for a logical format.

In step S402, either the mount historical information or the formatting historical information is selected as historical information with lower points, i.e., the lower degree of deviation from the user current preference on the basis of the result of comparison in step S401.

In step S403, a logical format having the largest number of registrations is recognized with reference to the historical information selected in step S402.

Processing in the above-described step S403 corresponds to that in step S301 in FIG. 9. Processing in the subsequent steps S404 to S409 is similar to that in steps S302 to S307 in FIG. 9. Accordingly, a description of step S404 to S409 is omitted.

If it is determined in step S409 that the OK button 83 is operated, it is determined in step S410 whether the logical format determined as a format to be used for formatting in accordance with the operation on the OK button 83 has been highlighted (selected) with the highlight frame 82 in the initial DVD formatting screen.

For example, referring to FIG. 8, the highlight frame 82 is arranged on the logical-format selection button 81-1 designating the DVD-Video format in the initial DVD formatting screen. In this case, if the logical-format selection button 81 highlighted with the highlight frame 82 when the OK button 83 is operated is the logical-format selection button 81-1 corresponding to the DVD-Video format, a positive determination is made in step S410. On the other hand, if the logical-format selection button 81 finally selected by the operation on the OK button 83 is the logical-format selection button 81-2 or 81-3 corresponding to another logical format different from the DVD-Video format, a negative determination is made in step S410.

If YES in step S410, the process skips step S411 and proceeds to step S412. If NO in step S410, the process proceeds to step S411.

In step S411, one point is given to the historical information selected in step S402, i.e., the historical information used for determination of the logical-format selection button 81 to be highlighted with the highlight frame 82 in the initial DVD formatting screen. Data regarding the points is stored in, for example, the nonvolatile memory 18d. As described above, when a logical format selected by the highlight frame 82 in the initial DVD formatting screen is not finally determined as a format for formatting by the user, a point is added to points of historical information used for determination of the logical-format selection button 81 highlighted with the highlight frame 82 in the initial DVD formatting screen. As described above, therefore, either the mount historical information or the formatting historical information, whichever has higher points, may have a higher degree of deviation from the user current preference.

After steps S410 and S411, in step S412, the loaded DVD is formatted in the logical format corresponding to the logical-format selection button 81 highlighted with the highlight frame 82 when the OK button 83 is operated in a manner similar to step S308 in FIG. 9.

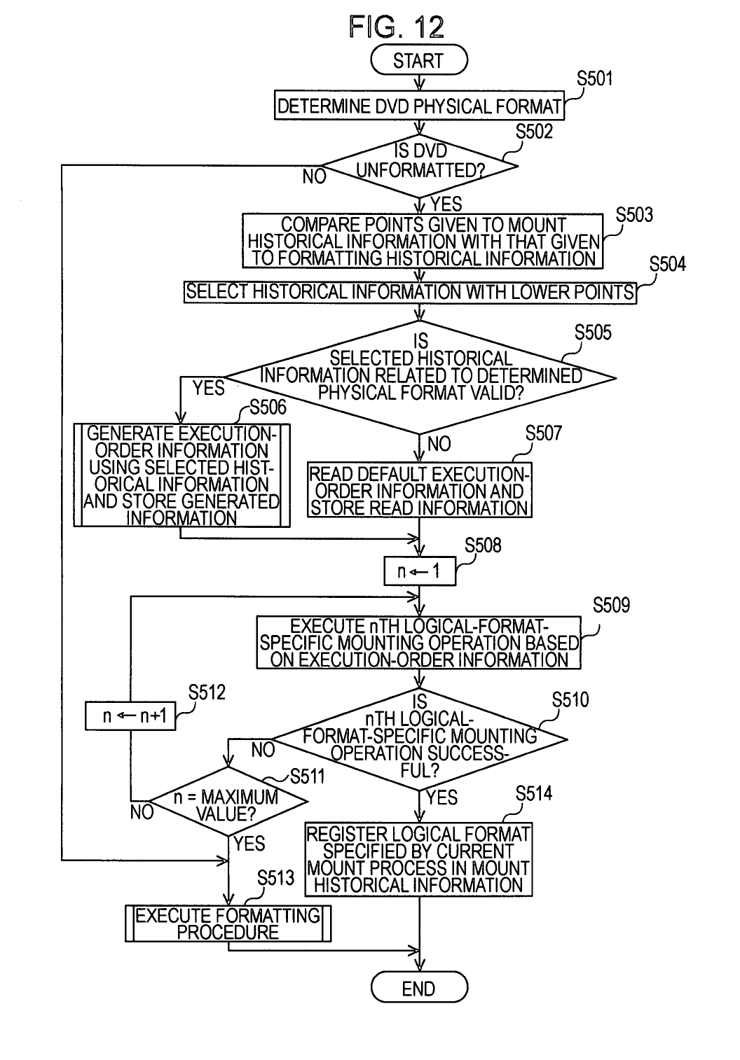

FIG. 12 is a flowchart of a mount process, involving determining the execution order of logical-format-specific mounting operations, according to the second modification.

Referring to FIG. 12, when it is determined in step S502 that a loaded DVD is formatted, i.e., if YES in step S502, processing in steps S503 and S504 similar to that in steps S401 and S402 is performed. Specifically, mount historical information and formatting historical information, related to the physical format of the loaded DVD, stored in the nonvolatile memory 18d are compared with each other with respect to points given thereto. Either historical information with lower points is selected. In step S505, it is determined whether the historical information selected in step S504 is valid. If YES in step S505, in step S506, execution-order information is generated using the historical information selected in step S504 and is stored in the RAM 18b in the same way as step S104 in FIG. 5. Processing in steps S507 to S514 is similar to that in steps S105 to S112 in FIG. 5. Formatting in step S513 is performed as shown in FIG. 11.

According to the second modification, historical information used for determination of the execution-order of logical-format-specific mounting operations and determination of any logical-format selection button 81 to be highlighted with the highlight frame 82 is selected using the degree of deviation from the user preference estimated on the basis of given points as the degree of reliability. Another method of selecting historical information may be available. According to another modification, mount historical information or formatting historical information, whichever has a larger number of registrations, may be selected as highly reliable information. This selecting method may be useful in a case where, for example, the number of historical items in each of mount historical information and formatting historical information is set to a relatively large value.

In the above-described second modification, either mount historical information or formatting historical information is selected and is used for determination of the execution order of logical-format-specific mounting operations and determination of any logical-format selection button 81 to be highlighted with the highlight frame 82. According to another modification, descriptions of both of mount historical information and formatting historical information may be used simultaneously. According to the simplest method, the sum of the number of registrations of each logical format in mount historical information and that of the same logical format in formatting historical information may be obtained and used. According to another modification, the number of registrations of each logical format in mount historical information and that of the same logical format in formatting historical information may be weighted and the sum of the weighted numbers may be used.

It should be understood that the present invention is not limited to the above-described embodiment and modifications.

For example, the above-described embodiment and modifications have taken a DVD to be subjected to a mount process (and formatting) as an example. Storage media other than DVDs may be used. Specifically, disk-shaped optical storage media, magnetic storage media, such as a magnetic disk, and other storage media, such as a semiconductor memory device, may be used.

In the above-described embodiment, the video camera 1 has been taken as an example of an apparatus for processing a storage medium according to the present invention. The present invention may be applied to other various apparatuses.

It should be understood by those skilled in the art that various modifications, combinations, sub-combinations and alterations may occur depending on design requirements and other factors insofar as they are within the scope of the appended claims or the equivalents thereof.

1. An apparatus for processing a storage medium, comprising:
recognizing means for sequentially executing logical-format-specific recognizing operations included in a storage-medium recognizing process for recognizing a storage medium loaded in a loading mechanism of the apparatus so that the storage medium is operable in a software layer, the storage medium having a predetermined physical format that supports two or more logical formats, the logical-format-specific recognizing operations being related to the logical formats, respectively;
generating means for generating logical-format historical information synchronously with the execution of a predetermined process, the logical-format historical information containing a history of logical formats specified by the predetermined processes performed on storage media loaded in the loading mechanism in the past;
storing means for storing the logical-format historical information; and
execution-order control means for determining the execution order of the logical-format-specific mounting operations executed by the recognizing means in accordance with the frequencies of occurrence of the respective logical formats described in the logical-format historical information stored in the storing means.

2. The apparatus according to claim 1, wherein the generating means generates the logical-format historical information such that the information describes a history of logical formats in storage media subjected to the storage-medium recognizing processes, each logical format being specified when the recognizing means performs the logical-format-specific recognizing operation related to the logical format and the operation is successful.

3. The apparatus according to claim 1, further comprising:
formatting means for formatting the loaded storage medium in a logical format selected from logical formats determined in accordance with the physical format of the loaded storage medium, wherein
the generating means generates the logical-format historical information such that the information describes a history of logical formats in formatted storage media, each logical format being specified as a result of formatting by the formatting means.

4. The apparatus according to claim 1, further comprising:
formatting means for formatting the storage medium loaded in the loading mechanism in a logical format selected from candidate logical formats determined in accordance with the physical format of the storage medium, wherein
the generating means generates recognition historical information and formatting historical information as the logical-format historical information, the recognition historical information describing a history of logical formats of storage media subjected to the storage-medium recognizing processes, each logical format in the history of the recognition historical information being specified when the logical-format-specific recognizing operation executed by the recognizing means is successful, the formatting historical information describing a history of logical formats of formatted storage media, each logical format in the history of the formatting historical information being specified as a result of formatting by the formatting means, and
the generating means includes historical-information selecting means for selecting either the recognition historical information or the formatting historical information as the logical-format historical information used by the execution-order control means on the basis of a predetermined selection criterion.

5. The apparatus according to claim 1, further comprising:
formatting-screen display means for performing display control of a formatting screen such that a plurality of logical formats, determined in accordance with the physical format of the storage medium to be formatted, are displayed as selection items for selection of a logical format used for formatting the storage medium and any one of the selection items is highlighted as a currently selected item;
selection-item control means for controlling the formatting-screen display means to highlight a selection item corresponding to a logical format determined on the basis of the frequencies of occurrence of the logical formats described in the logical-format historical information stored in the storing means when display of the formatting screen is started; and
formatting means for formatting the storage medium in a logical format corresponding to a selection item highlighted when an operation of determining the logical format is performed on the formatting screen.

6. A method for processing a storage medium, comprising:
sequentially executing logical-format-specific recognizing operations included in a storage-medium recognizing process for recognizing a storage medium loaded in a loading mechanism of a storage medium processing apparatus so that the storage medium is operable in a software layer, the storage medium having a predetermined physical format that supports two or more logical formats, the logical-format-specific recognizing operations being related to the logical formats, respectively;
generating logical-format historical information synchronously with the execution of a predetermined process and storing the generated information in storing means, the logical-format historical information containing a history of logical formats specified by the predetermined processes performed on storage media loaded in the loading mechanism in the past; and
determining the execution order of the logical-format-specific mounting operations in accordance with the frequencies of occurrence of the respective logical formats described in the logical-format historical information stored in the storing means.

7. A program that allows a storage medium processing apparatus to execute processing, the processing comprising:
sequentially executing logical-format-specific recognizing operations included in a storage-medium recognizing process for recognizing a storage medium loaded in a loading mechanism of a storage medium processing apparatus so that the storage medium is operable in a software layer, the storage medium having a predetermined physical format that supports two or more logical formats, the logical-format-specific recognizing operations being related to the logical formats, respectively;
generating logical-format historical information synchronously with the execution of a predetermined process and storing the generated information in storing means, the logical-format historical information containing a history of logical formats specified by the predetermined processes performed on storage media loaded in the loading mechanism in the past; and
determining the execution order of the logical-format-specific mounting operations in accordance with the frequencies of occurrence of the respective logical formats described in the logical-format historical information stored in the storing means.

8. An apparatus for processing a storage medium, comprising:
a recognizing unit that sequentially executes logical-format-specific recognizing operations included in a storage-medium recognizing process for recognizing a storage medium loaded in a loading mechanism of the apparatus so that the storage medium is operable in a software layer, the storage medium having a predetermined physical format that supports two or more logical formats, the logical-format-specific recognizing operations being related to the logical formats, respectively;
a generating unit that generates logical-format historical information synchronously with the execution of a predetermined process, the logical-format historical information containing a history of logical formats specified by the predetermined processes performed on storage media loaded in the loading mechanism in the past;
a storing unit that stores the logical-format historical information; and
an execution-order control unit that determines the execution order of the logical-format-specific mounting operations executed by the recognizing unit in accordance with the frequencies of occurrence of the respective logical formats described in the logical-format historical information stored in the storing unit.
